(19) United States
(12) Patent Application Publication
(10) Pub. No.: US 2024/0193753 A1
(43) Pub. Date: Jun. 13, 2024

(54) BATTERY CELL DETECTION APPARATUS

(71) Applicant: Supersonic Artificial Intelligence Technology Co., Ltd., Guangzhou (CN)

(72) Inventors: Junfeng ZHANG, Guangzhou (CN); Shidui WANG, Guangzhou (CN); Changchun YE, Guangzhou (CN); Hao LI, Guangzhou (CN)

(21) Appl. No.: 18/581,872

(22) Filed: Feb. 20, 2024

Related U.S. Application Data
(63) Continuation of application No. 17/651,989, filed on Feb. 22, 2022.

(51) Int. Cl. G06T 7/00; H01M 10/0525; H01M 10/058; H01M 10/48; H02J 7/00; H04N 23/55; H04N 23/56; H04N 23/90

(52) U.S. Cl. CPC G06T 7/0004; H01M 10/0525; H01M 10/058; H01M 10/48; H02J 7/0042; H04N 23/55; H04N 23/56; H04N 23/90; G06T 2207/30108

(57) ABSTRACT

The present invention discloses a battery cell detection apparatus. The battery cell detection apparatus includes a feeding manipulator, a discharging manipulator, a first transition manipulator, a second transition manipulator, a first transmission structure, a second transmission structure, a third transmission structure, a first lifting structure, a second lifting structure, a first detection structure, a second detection structure, and a third detection structure. According to the present invention, visual detection can be performed on a surface of a battery cell, and outer side surfaces and inner side surfaces of a first tab and a second tab. By using visual detection to substitute artificial identification, high detection efficiency can be achieved, and the occurrence of false detection can be greatly reduced, so that the quality of battery cell products can be effectively enhanced.

### CROSS REFERENCE TO RELATED APPLICATION

This application is a Continuation of the U.S. application Ser. No. 17/651,989 filed on Feb. 22, 2022, and entitled “BATTERY CELL DETECTION APPARATUS”, now pending, the entire disclosures of which are incorporated herein by reference.

### TECHNICAL FIELD

The present invention relates to the technical field of battery cells, and specifically, to a battery cell detection apparatus.

### BACKGROUND

The battery cell is a raw material of a lithium-ion polymer battery product. The battery cell is provided with tab portions. The tab portions are metal conductors that lead the positive and negative electrodes from the battery cell, which generally are the ears of the positive and negative electrodes of the battery. One battery cell will extend two tab portions, and the tab portions are used as contact points during charging and discharging of the battery. Each of the tab portions includes a plurality of tabs.

During production of the lithium battery, whether the quantity of tabs of the battery cell is correct and whether the tabs are folded are important factors directly related to the quality of the lithium battery product. Therefore, it is required to detect abnormal situations of whether the quantity of tabs of the battery cell is correct and whether the tabs are folded. In addition, there may be flaws such as dents, convex marks, pits, bumps, and the like on the surface appearance of some battery cells, which affect the appearance and have large impact on safe production and use of the battery cells. Therefore, the surfaces of the battery cells need to be detected after production.

However, a conventional method mainly relies on manually detecting the abnormal situations of whether the quantity of tabs of the battery cell is correct and whether the tabs are folded and whether there are flaws on the surface of the battery cell, that is, performing observation through human eyes. However, human eye detection is inefficient and prone to false detections, which affects product quality.

### SUMMARY

### I. Technical Problem to be Resolved

In view of the disadvantages in the prior art, the present invention provides a battery cell detection apparatus, to resolve the technical problem.

### II. Technical Solution

In order to resolve the above technical problem, the present invention provides the following technical solution. A battery cell detection apparatus is provided and includes a feeding manipulator, a discharging manipulator, a first transition manipulator, a second transition manipulator, a first transmission structure, a second transmission structure, a third transmission structure, a first lifting structure, a second lifting structure, a first detection structure, a second detection structure, and a third detection structure. The first transmission structure is disposed parallel to the third transmission structure. The feeding manipulator is disposed close to an inlet side of the first transmission structure. The discharging manipulator is disposed close to an outlet side of the third transmission structure. The first lifting structure is disposed close to an outlet side of the first transmission structure. The second lifting structure is disposed close to an inlet side of the third transmission structure. The second transmission structure is located above the first transmission structure and the third transmission structure. An inlet side of the second transmission structure is disposed close to the first lifting structure. An outlet side of the second transmission structure is disposed close to the second lifting structure. The first transition manipulator is disposed close to the inlet side of the second transmission structure and the first lifting structure. The second transition manipulator is disposed close to the outlet side of the second transmission structure and the second lifting structure. The first detection structure is disposed close to the first lifting structure. The second detection structure is disposed close to the second transmission structure. The third detection structure is disposed close to the second lifting structure. The feeding manipulator is configured to feed a to-be-detected battery cell to the inlet side of the first transmission structure. A first tab and a second tab are disposed on a side of the battery cell at intervals. The first transmission structure is configured to horizontally transmit the battery cell to the first lifting structure. The first lifting structure is configured to lift the battery cell. The first detection structure is configured to photograph an inner side surface of the first tab and an outer side surface of the second tab of the battery cell located on the first lifting structure. The first transition manipulator is configured to transit the battery cell from the first lifting structure to the inlet side of the second transmission structure. The second transmission structure is configured to horizontally transmit the battery cell. The second detection structure is configured to photograph a surface of the battery cell located on the second transmission structure. The second transition manipulator is configured to transit the battery cell from the outlet side of the second transmission structure to the second lifting structure. The second lifting structure is configured to land the battery cell. The third detection structure is configured to photograph an outer side surface of the first tab and an inner side surface of the second tab of the battery cell located on the second lifting structure. The third transmission structure is configured to horizontally transmit the battery cell landed by the second lifting structure. The discharging manipulator is configured to discharge the battery cell located on the outlet side of the third transmission structure.

Preferably, a quantity of the battery cell detection apparatuses is two. The two battery cell detection apparatuses are in axially symmetrical arrangement.

Preferably, the first detection structure includes a first visual camera, a second visual camera, and a first prism. The first visual camera and the second visual camera both are located on a side of the first lifting structure. A photographing direction of the first visual camera is perpendicular to a photographing direction of the second visual camera. The first prism is disposed in front of the first visual camera. A mirror surface of the first prism is configured to reflect the inner side surface of the first tab. The first visual camera is configured to photograph the mirror surface of the first prism. The second visual camera is configured to photograph the outer side surface of the second tab.

Preferably, the first visual camera is disposed above the second visual camera.

Preferably, the second detection structure includes a third visual camera and a fourth visual camera. The third visual camera and the fourth visual camera are respectively located on two sides of the second transmission structure. The third visual camera and the fourth visual camera both are configured to photograph an upper surface of the battery cell.

Preferably, the second detection structure further includes a fifth visual camera and a sixth visual camera. The fifth visual camera is disposed under the third visual camera. The sixth visual camera is disposed under the fourth visual camera. The fifth visual camera and the sixth visual camera both are configured to photograph a lower surface of the battery cell.

Preferably, the second detection structure further includes a first light source member, a second light source member, a third light source member, and a fourth light source member. The first light source member and the third light source member are spaced apart from each other in an up and down manner and both are located on one side of the second transmission structure. The second light source member and the fourth light source member are spaced apart from each other in an up and down manner and both are located on the other side of the second transmission structure. The first light source member and the second light source member both irradiate towards the upper surface of the battery cell. The third light source member and the fourth light source member both irradiate towards the lower surface of the battery cell.

Preferably, the third detection structure includes a seventh visual camera, an eighth visual camera, and a second prism. The seventh visual camera and the eighth visual camera both are located on a side of the second lifting structure. A photographing direction of the seventh visual camera is perpendicular to a photographing direction of the eighth visual camera. The second prism is disposed in front of the seventh visual camera. A mirror surface of the second prism is configured to reflect the inner side surface of the second tab. The seventh visual camera is configured to photograph the mirror surface of the second prism. The eighth visual camera is configured to photograph the outer side surface of the first tab.

Preferably, the seventh visual camera is disposed above the eighth visual camera.

Preferably, the first lifting structure includes two vertical plates, a first chain, a second chain, a first rotary rod, a second rotary rod, a motor, and a supporting apparatus. The two vertical plates are disposed opposite to each other. The first rotary rod and the second rotary rod are arranged at intervals on the two vertical plates in an up and down manner. The motor is disposed on one of the vertical plates and connected to an end of the first rotary rod. Top ends of the first chain and the second chain are arranged at intervals on the first rotary rod. Bottom ends of the first chain and the second chain are arranged at intervals on the second rotary rod. Two ends of the supporting apparatus are respectively disposed on the first chain and the second chain.

### III. Beneficial Effects

Compared with the prior art, the present invention provides the battery cell detection apparatus, and has the following beneficial effects: (1) The second detection structure is configured to photograph the surface of the battery cell located on the second transmission structure. The first detection structure is configured to photograph the inner side surface of the first tab and the outer side surface of the second tab of the battery cell located on the first lifting structure. The third detection structure is configured to photograph the outer side surface of the first tab and the inner side surface of the second tab of the battery cell located on the second lifting structure. Therefore, visual detection can be performed on the surface of the battery cell, and the outer side surfaces and the inner side surfaces of the first tab and the second tab. That is to say, automatic detection on the surface appearance of the battery cell and abnormal situations of whether the quantity of tabs of the battery cell is correct and whether the tabs are folded can be realized. By using visual detection to substitute artificial identification, high detection efficiency can be achieved, and the occurrence of false detection can be greatly reduced, so that the quality of battery cell products can be effectively enhanced. (2) Through the arrangement of the feeding manipulator, the discharging manipulator, the first transition manipulator, the second transition manipulator, the first transmission structure, the second transmission structure, and the third transmission structure, automatic transport of the whole process of feeding, transmitting and discharging battery cells can be realized, thereby further enhancing the detection efficiency.

### BRIEF DESCRIPTION OF THE DRAWINGS

FIG. 1 is a first schematic three-dimensional view of a battery cell detection apparatus according to the present invention.

FIG. 2 is a second schematic three-dimensional view of a battery cell detection apparatus according to the present invention.

FIG. 3 is a schematic three-dimensional view of two battery cell detection apparatuses according to the present invention.

FIG. 4 is a schematic three-dimensional view of a first lifting structure, a first transmission structure, a first detection structure, a feeding manipulator, and a first transition manipulator according to the present invention.

FIG. 5 is a first schematic three-dimensional view of a first lifting structure, a second lifting structure, a first detection structure, and a third detection structure according to the present invention.

FIG. 6 is a second schematic three-dimensional view of a first lifting structure, a second lifting structure, a first detection structure, and a third detection structure according to the present invention.

FIG. 7 is a first schematic three-dimensional view of a first lifting structure and a first detection structure according to the present invention.

FIG. 8 is a second schematic three-dimensional view of a first lifting structure and a first detection structure according to the present invention.

FIG. 9 is a first schematic three-dimensional view of a first lifting structure according to the present invention.

FIG. 10 is a second schematic three-dimensional view of a first lifting structure according to the present invention.

FIG. 11 is a schematic three-dimensional view of a supporting apparatus of a first lifting structure according to the present invention.

FIG. 12 is a schematic three-dimensional view of a first visual camera and a first prism according to the present invention.

FIG. 13 is a schematic three-dimensional view of a battery cell.

FIG. 14 is a schematic three-dimensional view of a second transmission structure, a second detection structure, a first transition manipulator, and a second transition manipulator according to the present invention.

FIG. 15 is a schematic three-dimensional view of a second transmission structure and a second detection structure according to the present invention.

FIG. 16 is a schematic three-dimensional view of a second detection structure according to the present invention.

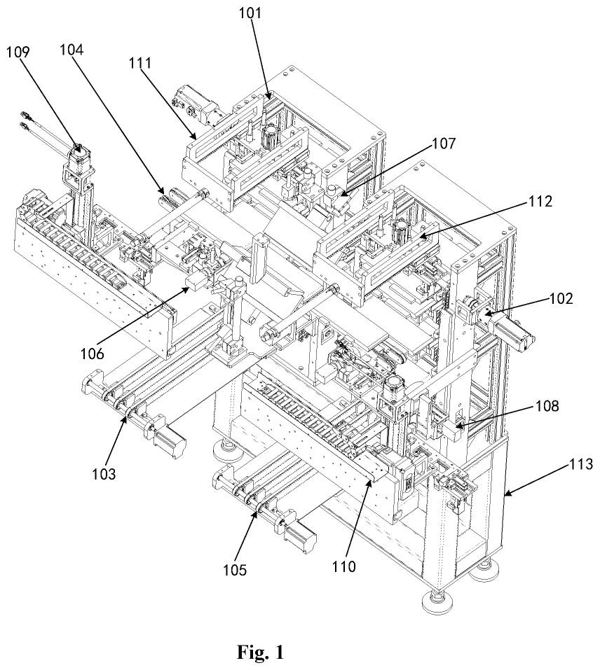

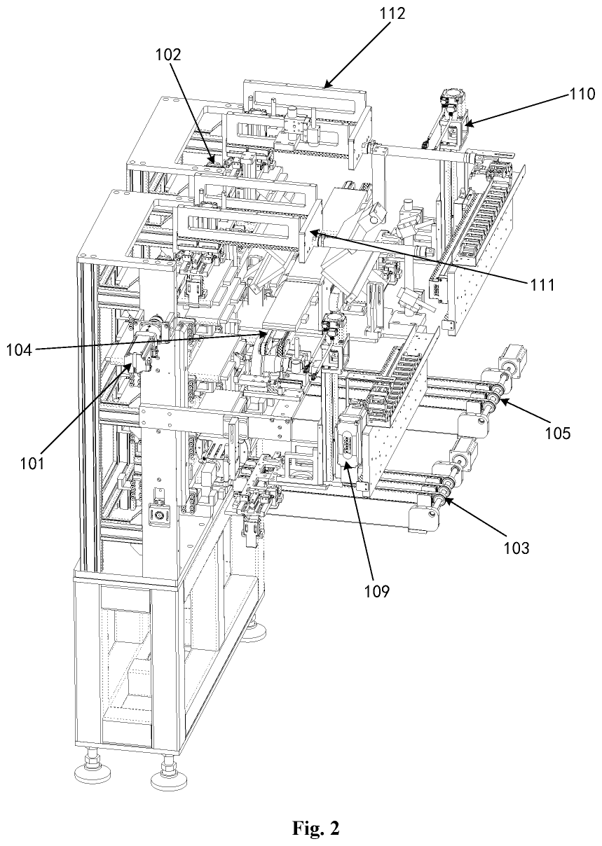

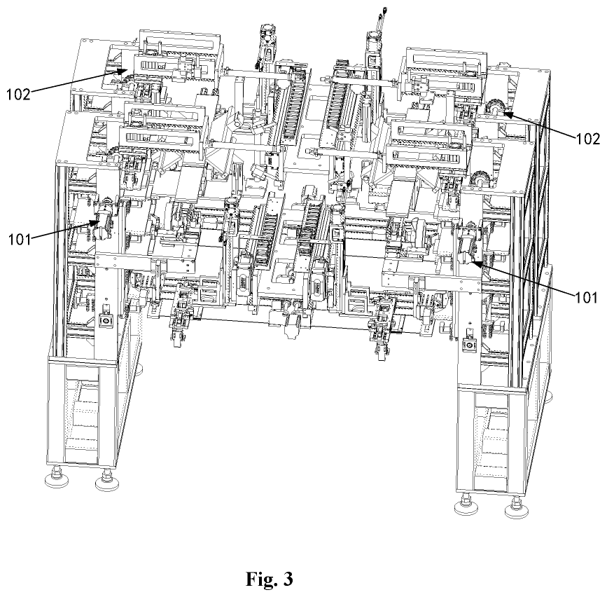

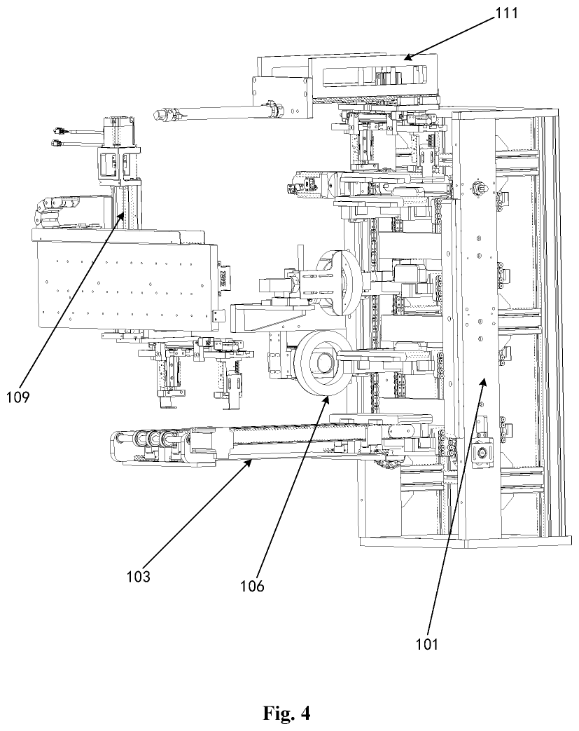

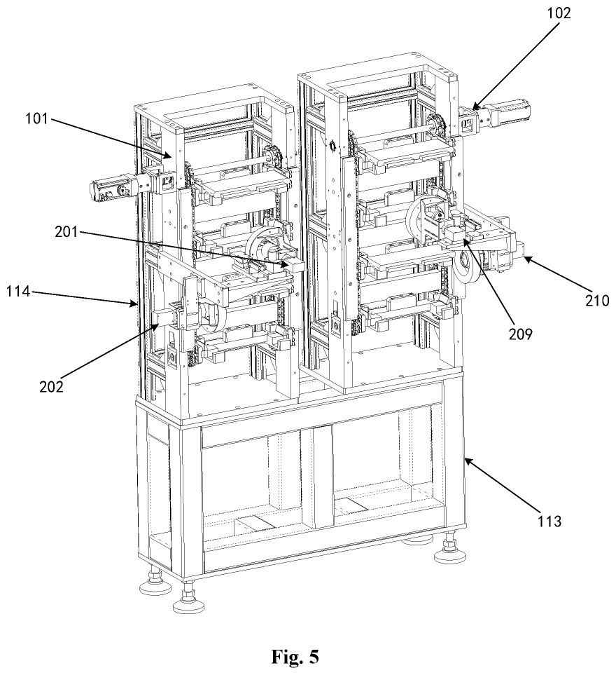

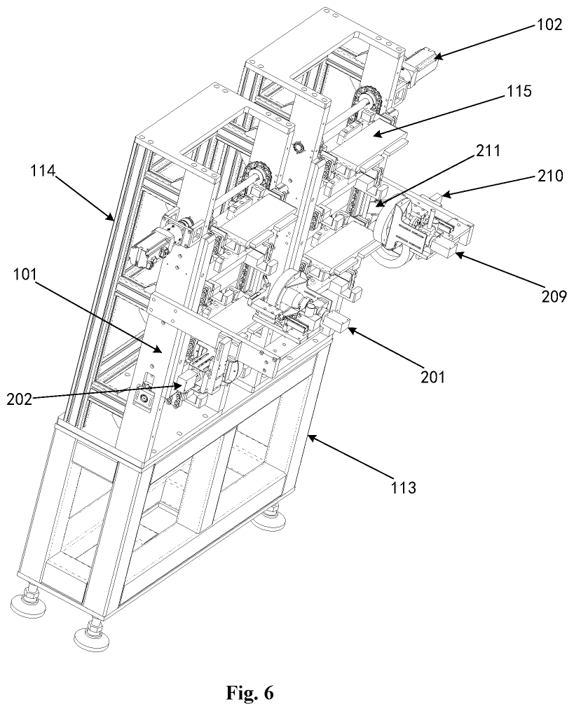

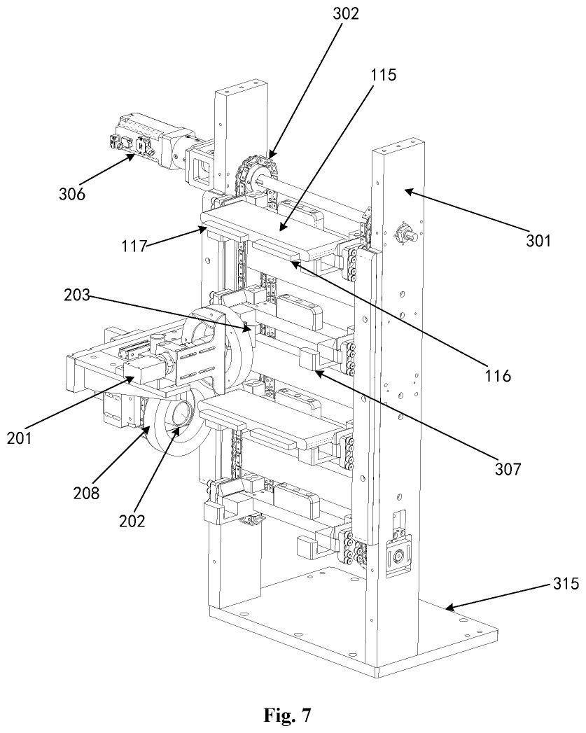

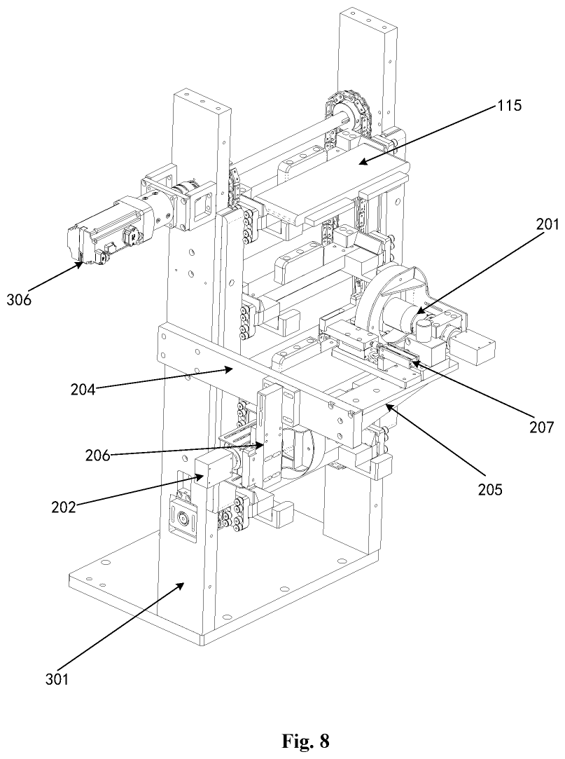

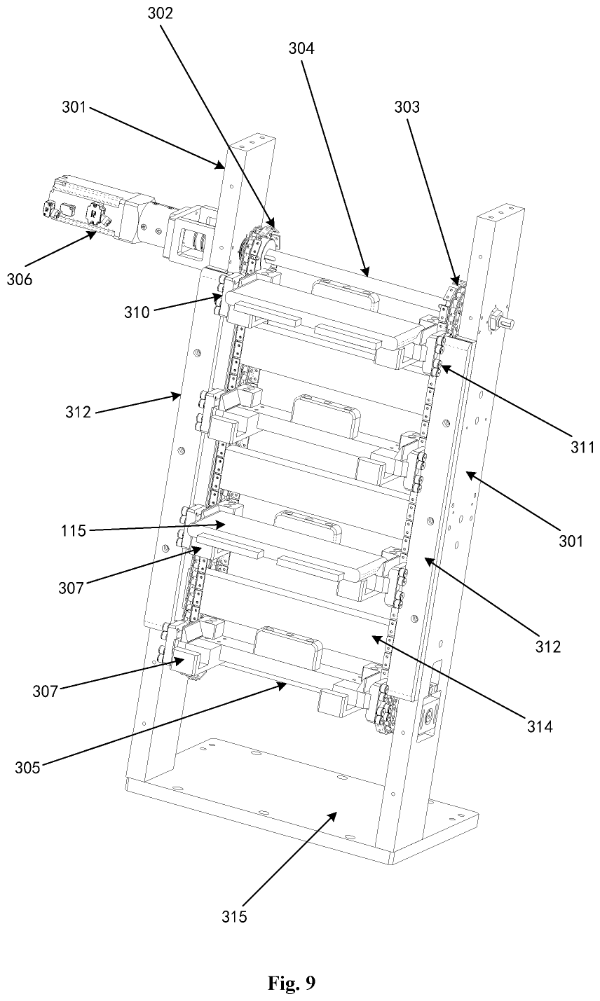

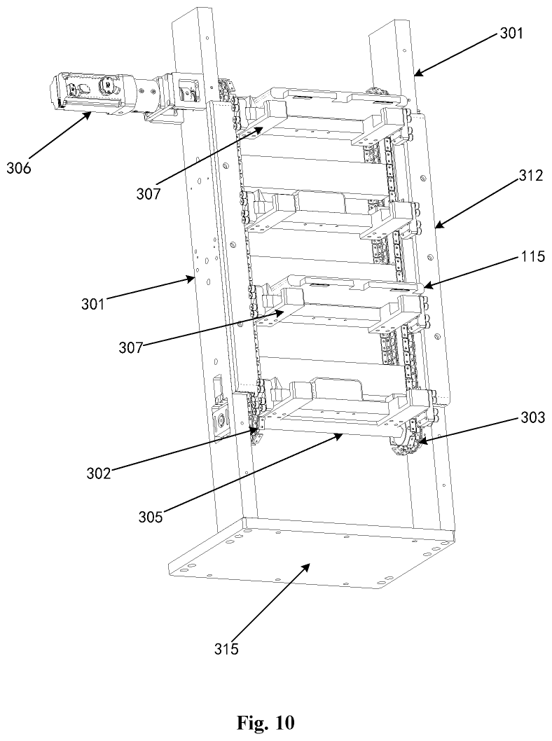

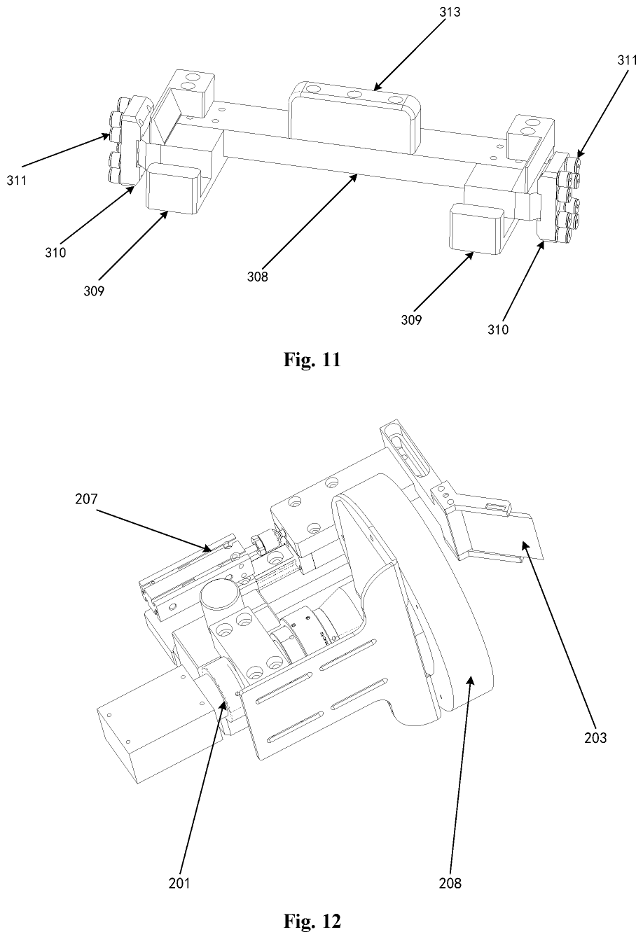

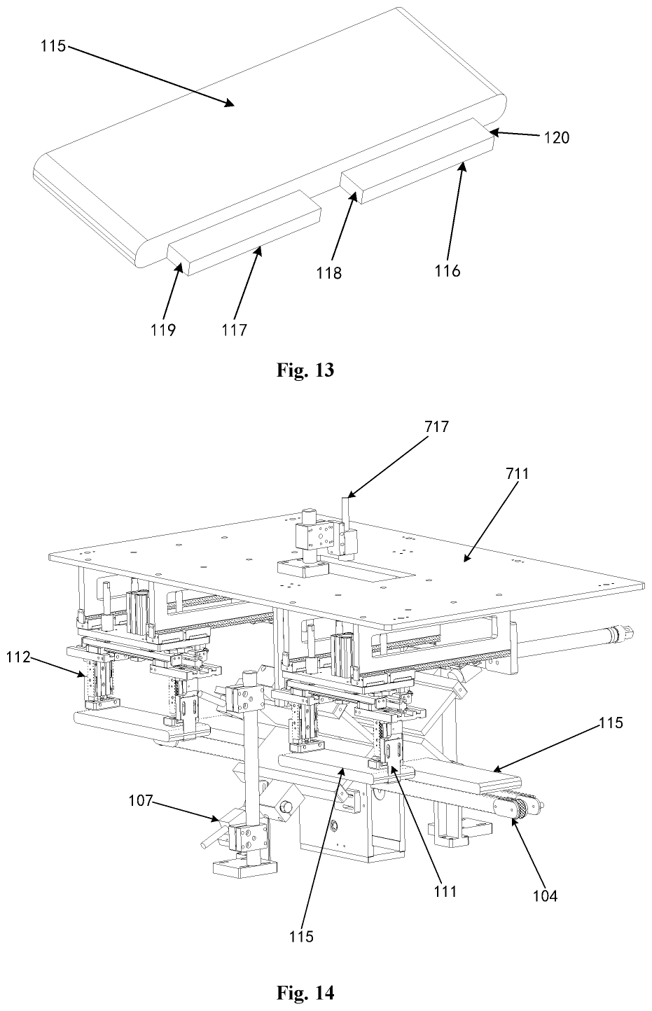

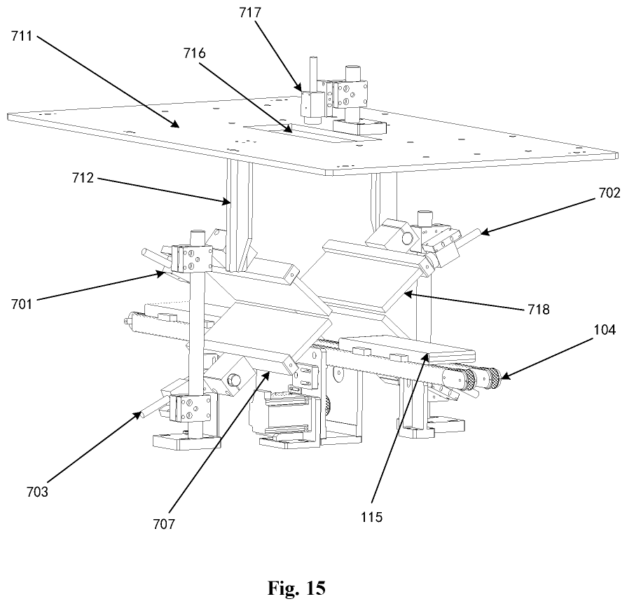

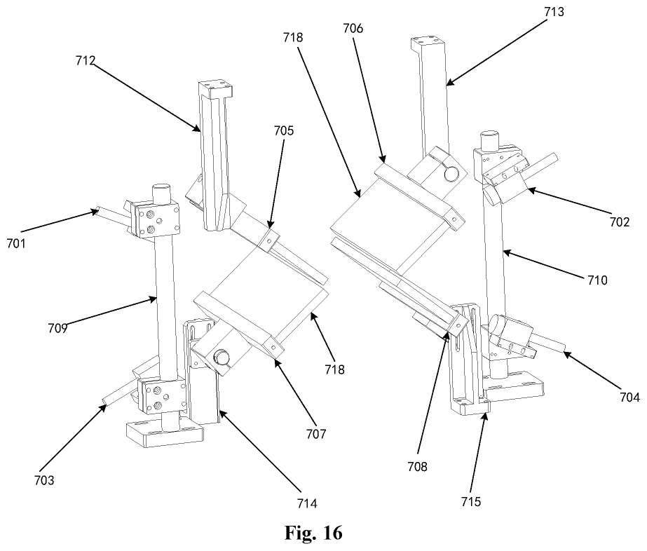

Reference numerals: 101 First lifting structure, 102 Second lifting structure, 103 First transmission structure, 104 Second transmission structure, 105 Third transmission structure, 106 First detection structure, 107 Second detection structure, 108 Third detection structure, 109 Feeding manipulator, 110 Discharging manipulator, 111 First transition manipulator, 112 Second transition manipulator, 113 Fixing platform, 114 Fixing frame, 115 Battery cell, 116 First tab, 117 Second tab, 118 Inner side surface of first tab, 119 Outer side surface of second tab, 120 Outer side surface of first tab, 201 First visual camera, 202 Second visual camera, 203 First prism, 204 First fixing plate, 205 Second fixing plate, 206 Third fixing plate, 207 Horizontal sliding apparatus, 208 Fifth light source member, 209 Seventh visual camera, 210 Eighth visual camera, 211 Second prism, 301 Vertical plate, 302 First chain, 303 Second chain, 304 First rotary rod, 305 Second rotary rod, 306 Motor, 307 Supporting apparatus, 308 Connecting bar, 309 Supporting block, 310 Sliding block, 311 Pulley, 312 Sliding plate, 313 Baffle, 314 Reinforcing plate, 315 Base plate, 701 Third visual camera, 702 Fourth visual camera, 703 Fifth visual camera, 704 Sixth visual camera, 705 First light source member, 706 Second light source member, 707 Third light source member, 708 Fourth light source member, 709 First fixing rod, 710 Second fixing rod, 711 Top plate, 712 First fixing apparatus, 713 Second fixing apparatus, 714 Third fixing apparatus, 715 Fourth fixing apparatus, 716 Through hole, 717 Positioning camera, 718 Irradiation direction of each light source member of second detection structure.

### DETAILED DESCRIPTION OF THE EMBODIMENTS

The technical solutions in the embodiments of the present invention will be clearly and completely described below in combination with the drawings in the embodiments of the present invention. It is apparent that the described embodiments are only part of the embodiments of the present invention, not all the embodiments. Based on the embodiments in the present invention, all other embodiments obtained by those of ordinary skilled in the art without creative work shall fall within the protection scope of the present invention.

A battery cell detection apparatus in the present invention includes a feeding manipulator 109, a discharging manipulator 110, a first transition manipulator 111, a second transition manipulator 112, a first transmission structure 103, a second transmission structure 104, a third transmission structure 105, a first lifting structure 101, a second lifting structure 102, a first detection structure 106, a second detection structure 107, and a third detection structure 108. The first transmission structure 103 is disposed parallel to the third transmission structure 105. The feeding manipulator 109 is disposed close to an inlet side of the first transmission structure 103. The discharging manipulator 110 is disposed close to an outlet side of the third transmission structure 105. The first lifting structure 101 is disposed close to an outlet side of the first transmission structure 103. The second lifting structure 102 is disposed close to an inlet side of the third transmission structure 105. The second transmission structure 104 is located above the first transmission structure 103 and the third transmission structure 105. An inlet side of the second transmission structure 104 is disposed close to the first lifting structure 101. An outlet side of the second transmission structure 104 is disposed close to the second lifting structure 102. The first transition manipulator 111 is disposed close to the inlet side of the second transmission structure 104 and the first lifting structure 101. The second transition manipulator 112 is disposed close to the outlet side of the second transmission structure 104 and the second lifting structure 102. The first detection structure 106 is disposed close to the first lifting structure 101. The second detection structure 107 is disposed close to the second transmission structure 104. The third detection structure 108 is disposed close to the second lifting structure 102.

The feeding manipulator 109 is configured to feed a to-be-detected battery cell 115 to the inlet side of the first transmission structure 103. A first tab 116 and a second tab 117 are disposed on a side of the battery cell 115 at intervals. The first transmission structure 103 is configured to horizontally transmit the battery cell 115 to the first lifting structure 101. The first lifting structure 101 is configured to lift the battery cell 115. The first detection structure 106 is configured to photograph an inner side surface 118 of the first tab 116 and an outer side surface 119 of the second tab 117 of the battery cell located on the first lifting structure 101. The first transition manipulator 111 is configured to transit the battery cell 115 from the first lifting structure 101 to the inlet side of the second transmission structure 104. The second transmission structure 104 is configured to horizontally transmit the battery cell 115. The second detection structure 107 is configured to photograph a surface of the battery cell located on the second transmission structure 104. The second transition manipulator 112 is configured to transit the battery cell 115 from the outlet side of the second transmission structure 104 to the second lifting structure 102. The second lifting structure 102 is configured to land the battery cell 115. The third detection structure 108 is configured to photograph an outer side surface 120 of the first tab and an inner side surface of the second tab 117 of the battery cell located on the second lifting structure 102. The third transmission structure 105 is configured to horizontally transmit the battery cell 115 landed by the second lifting structure 102. The discharging manipulator 110 is configured to discharge the battery cell 115 located on the outlet side of the third transmission structure 105.

A working principle of the battery cell detection apparatus in the present invention includes the following: The feeding manipulator 109 feeds the to-be-detected battery cell 115 to the first transmission structure 103. The first transmission structure 103 horizontally transmits the battery cell 115 to the first lifting structure 101. The first lifting structure 101 lifts the battery cell 115 transmitted by the first transmission structure 103. When the battery cell 115 on the first lifting structure 101 correspondingly passes through a photographing range of the first detection structure 106, the first detection structure 106 correspondingly photographs the inner side surface 118 of the first tab and the outer side surface 119 of the second tab, so as to correspondingly obtain photographing images. Further, the first transition manipulator 111 grabs the battery cell 115 on the first lifting structure 101 to the second transmission structure 104 for transmission. When the battery cell 115 passes through a photographing range of the second detection structure 107, the second detection structure 107 photographs the surface of the battery cell 115. Further, the second transition manipulator 112 grabs the battery cell 115 on the second transmission structure 104 to the second lifting structure 102. The second lifting structure 102 lands the battery cell 115. When the battery cell 115 passes through a photographing range of the third detection structure 108, the third detection structure 108 photographs the outer side surface 120 of the first tab and the inner side surface of the second tab 117. Then, the second lifting structure 102 lands the battery cell 115 that is detected to the third transmission structure 105. The third transmission structure 105 horizontally transmits the battery cell 115 landed by the second lifting structure 102. The discharging manipulator 110 discharges the battery cell 115 located on the outlet side of the third transmission structure 105.

The first detection structure 106, the second detection structure 107, and the third detection structure 108 all include visual cameras for photographing. The visual cameras are connected to an image processor, to transmit photographed images to the image processor for visual detection, so as to detect and identify whether there are flaws such as dents, convex marks and the like on the surface of the battery cell 115 photographed by the second detection structure 107, to detect and identify whether the quantity of the first tab 116 and the second tab 117 photographed by the first detection structure 106 and the third detection structure 108, and to detect and identify whether the first tab 116 and the second tab 117 are folded. For example, the quantity of the tabs on images photographed by the first detection structure 106 is identified through detection and is counted, and then a detection result can be obtained by comparing the counted quantity with a quantity of normal tabs. For example, whether the tabs on the images photographed by the first detection structure 106 are folded is identified through detection to obtain a corresponding folding detection result. Visual detection is image recognition, and its detection and identification principle based on the photographed images is an existing technology, which is not described again in this application.

Compared with the prior art, the present invention provides the battery cell detection apparatus, and has the following beneficial effects: (1) The second detection structure is configured to photograph the surface of the battery cell located on the second transmission structure. The first detection structure is configured to photograph the inner side surface of the first tab and the outer side surface of the second tab of the battery cell located on the first lifting structure. The third detection structure is configured to photograph the outer side surface of the first tab and the inner side surface of the second tab of the battery cell located on the second lifting structure. Therefore, visual detection can be performed on the surface of the battery cell, and the outer side surfaces and the inner side surfaces of the first tab and the second tab. That is to say, automatic detection on the surface appearance of the battery cell and abnormal situations of whether the quantity of tabs of the battery cell is correct and whether the tabs are folded can be realized. By using visual detection to substitute artificial identification, high detection efficiency can be achieved, and the occurrence of false detection can be greatly reduced, so that the quality of battery cell products can be effectively enhanced. (2) Through the arrangement of the feeding manipulator, the discharging manipulator, the first transition manipulator, the second transition manipulator, the first transmission structure, the second transmission structure, and the third transmission structure, automatic transport of the whole process of feeding, transmitting and discharging battery cells can be realized, thereby further enhancing the detection efficiency.

Preferably, a quantity of the battery cell detection apparatuses is two. The two battery cell detection apparatuses are in axially symmetrical arrangement. Therefore, dual channel detection of the battery cell can be realized, thereby further enhancing the detection efficiency of the battery cell.

The first detection structure 106 and the first lifting structure 101 of this implementation are described in detail below.

The first detection structure 106 includes a first visual camera 201, a second visual camera 202, and a first prism 203. The first visual camera 201 and the second visual camera 202 both are located on a side of the first lifting structure 101. A photographing direction of the first visual camera 201 is perpendicular to a photographing direction of the second visual camera 202. The first prism 203 is disposed in front of the first visual camera 201. A mirror surface of the first prism 203 is configured to reflect the inner side surface 118 of the first tab 116. The first visual camera 201 is configured to photograph the mirror surface of the first prism 203. The second visual camera 202 is configured to photograph the outer side surface 119 of the second tab 117. It may be understood that, the first prism 203 is configured to reflect the inner side surface 118 of the first tab 116, and the first visual camera 201 is configured to photograph the mirror surface of the first prism 203, so that the first visual camera 201 can photograph the inner side surface 118 of the first tab 116.

In this implementation, the first lifting structure 101 includes two vertical plates 301, a first chain 302, a second chain 303, a first rotary rod 304, a second rotary rod 305, a motor 306, and a supporting apparatus 307. The two vertical plates 301 are disposed opposite to each other. The first rotary rod 304 and the second rotary rod 305 are arranged at intervals on the two vertical plates 301 in an up and down manner. The motor 306 is disposed on one of the vertical plates 301 and connected to an end of the first rotary rod 304. Top ends of the first chain 302 and the second chain 303 are arranged at intervals on the first rotary rod 304. Bottom ends of the first chain 302 and the second chain 303 are arranged at intervals on the second rotary rod 305. Two ends of the supporting apparatus 307 are respectively disposed on the first chain 302 and the second chain 303.

A working principle of the first lifting structure 101 of this implementation includes the following: The motor 306 drives the first rotary rod 304 to rotate, that is, drives the first chain 302, the second chain 303, and the second rotary rod 305 to synchronously rotate. That is to say, the first chain 302 and the second chain 303 synchronously drive the supporting apparatus 307 to go up or go down. The battery cell 115 is placed on the supporting apparatus 307. It may be understood that, the supporting apparatus 307 can be operated from a side of the first lifting structure 101 to the corresponding other side of the first lifting structure 101 along rotation tracks of the first chain 302 and the second chain 303.

Specifically, the supporting apparatus 307 includes a connecting bar 308, a supporting block 309, and two sliding blocks 310. Two ends on a rear side of the connecting bar 308 are respectively disposed on the first chain 302 and the second chain 303. The two sliding blocks 310 are respectively disposed on two ends on a front side of the connecting bar 308. The sliding blocks 310 are provided with pulleys 311. The supporting block 309 is disposed on the connecting bar 308 and located between the two sliding blocks 310. In addition, sliding plates 312 are disposed on one sides of the two vertical plates 301. Preferably, the quantity of the pulleys 311 is plural. The plurality of pulleys 311 are distributed on the sliding blocks 310 in two columns. The two columns of pulleys 311 are located on two sides of the sliding plates 312. The pulleys 311 slide on the sliding plates 312. A baffle 313 is disposed on a rear side of the connecting bar 308, and is configured to block the battery cell 115. Preferably, the quantity of the supporting block 309 is plural. The plurality of supporting blocks 309 are arranged at intervals.

In addition, in order to improve the stability of the first lifting structure 101, a reinforcing plate 314 is disposed between the two vertical plates 301. Preferably, the quantity of the reinforcing plates 314 is plural. The plurality of reinforcing plates 314 are arranged at intervals in an up and down manner.

In this implementation, the first lifting structure 101 further includes a base plate 315. Bottoms of the two vertical plates 301 are disposed on the base plate 315.

In this implementation, the first visual camera 201 is disposed above the second visual camera 202. Specifically, this implementation further includes a first fixing plate 204, a second fixing plate 205, and a third fixing plate 206. An end of the first fixing plate 204 is disposed on the first lifting structure 101. An end of the second fixing plate 205 is disposed on a side of the first fixing plate 204. A top end of the third fixing plate 206 is disposed on the other side of the first fixing plate 204. The first visual camera 201 and the first prism 203 are disposed on the second fixing plate 205. The second visual camera 202 is disposed on the third fixing plate 206. Further, a horizontal sliding apparatus 207 is disposed on the second fixing plate 205. The first prism 203 is disposed on the horizontal sliding apparatus 207 to adjust a position of the first prism 203. The horizontal sliding apparatus 207 may specifically be an air cylinder sliding block apparatus or an electric sliding table. In this implementation, the first fixing plate 204 is specifically disposed in a middle position of one of the vertical plates 301. Definitely, the first fixing plate 204 may further be disposed in other positions such as tops close to the vertical plates 301, which is not excessively limited herein.

It may be understood that, when the first transmission structure 103 horizontally transmits the to-be-detected battery cell 115 to a side of the first lifting structure 101, the supporting block 309 of the first lifting structure 101 is controlled to lift so as to carry the battery cell 115 of the first transmission structure 103 on the supporting block 309. The supporting apparatus 307 of the first lifting structure 101 lifts the to-be-detected battery cell 115 upwards. When the battery cell 115 is lifted to pass through a photographing range of the second visual camera 202, the second visual camera 202 photographs the outer side surface 119 of the second tab 117 of the battery cell 115. The first tab 116 of the battery cell 115 further passes through a mirror reflection range of the first prism 203. The first visual camera 201 corresponding photographs the mirror surface of the first prism 203, to obtain a photographed image of the inner side surface 118 of the first tab 116.

In this implementation, a fixing platform 113 is further disposed. The first lifting structure 101 and the second lifting structure 102 are arranged at intervals on the fixing platform 113 in a left and right manner. In order to further improve the stability, the first lifting structure 101 and the second lifting structure 102 both are provided with fixing frames 114. In this implementation, a structure of the second lifting structure 102 is the same as a structure of the first lifting structure 101. Definitely, in other implementations, the first lifting structure 101 and the second lifting structure 102 may further be disposed in other structural forms such as air cylinders that can realize the lifting of the battery cell 115, which are not excessively limited herein.

The third detection structure 108 includes a seventh visual camera 209, an eighth visual camera 210, and a second prism 211. The seventh visual camera 209 and the eighth visual camera 210 both are located on a side of the second lifting structure 102. A photographing direction of the seventh visual camera 209 is perpendicular to a photographing direction of the eighth visual camera 210. The second prism 211 is disposed in front of the seventh visual camera 209. A mirror surface of the second prism 211 is configured to reflect the inner side surface of the second tab 117. The seventh visual camera 209 is configured to photograph the mirror surface of the second prism 211, which is similar to the first visual camera 201 of the above first detection structure. The seventh visual camera 209 can photograph the inner side surface of the second tab 117. The eighth visual camera 210 is configured to photograph the outer side surface 120 of the first tab 116. The seventh visual camera 209 is disposed above the eighth visual camera 210. The seventh visual camera 209 and the eighth visual camera 210 both are disposed away from the first lifting structure 101. Preferably, in order to achieve a better photographing effect, front ends of the first visual camera 201, the second visual camera 202, the seventh visual camera 209, and the eighth visual camera 210 are provided with fifth light source members 208. In this implementation, the third detection structure 108 and the first detection structure 106 have a similar structure. Therefore, the third detection structure 108 is not described again.

The second detection structure 107 is described in detail below.

In this implementation, the second detection structure 107 includes a third visual camera 701, a fourth visual camera 702, a fifth visual camera 703, and a sixth visual camera 704. The third visual camera 701 and the fourth visual camera 702 are respectively located on two sides of the second transmission structure 104. The third visual camera 701 and the fourth visual camera 702 both are configured to photograph an upper surface of the battery cell 115. The fifth visual camera 703 is disposed under the third visual camera 701. The sixth visual camera 704 is disposed under the fourth visual camera 702. The fifth visual camera 703 and the sixth visual camera 704 both are configured to photograph a lower surface of the battery cell 115.

In order to achieve the better photographing effect, the second detection structure 107 further includes a first light source member 705, a second light source member 706, a third light source member 707, and a fourth light source member 708. The first light source member 705 and the third light source member 707 are spaced apart from each other in an up and down manner and both are located on one side of the second transmission structure 104. The second light source member 706 and the fourth light source member 708 are spaced apart from each other in an up and down manner and both are located on the other side of the second transmission structure 104. The first light source member 705 and the second light source member 706 both irradiate towards the upper surface of the battery cell 115. The third light source member 707 and the fourth light source member 708 both irradiate towards the lower surface of the battery cell 115. The first light source member 705 is configured to create a better photographing light environment for the third visual camera 701. The second light source member 706 is configured to create a better photographing light environment for the fourth visual camera 702. The third light source member 707 is configured to create a better photographing light environment for the fifth visual camera 703. The fourth light source member 708 is configured to create a better photographing light environment for the sixth visual camera 704. In the drawings, the reference numeral 718 indicates the irradiation direction of each light source element of the second detection structure. The first light source member 705, the second light source member 706, the third light source member 707, and the fourth light source member 708 may specifically be strip-shaped light sources.

In addition, this implementation further includes a first fixing rod 709 and a second fixing rod 710. The third visual camera 701 and the fifth visual camera 703 are arranged at intervals on the first fixing rod 709 in an up and down manner. The fourth visual camera 702 and the sixth visual camera 704 are arranged at intervals on the second fixing rod 710 in an up and down manner. The first fixing rod 709 and the second fixing rod 710 are respectively located on two sides of the second transmission structure 104.

This implementation further includes a top plate 711. A first fixing apparatus 712 and a second fixing apparatus 713 are disposed on a bottom surface of the top plate 711. The first light source member 705 is disposed on the first fixing apparatus 712. The second light source member 706 is disposed on the second fixing apparatus 713. A third fixing apparatus 714 is disposed under the first fixing apparatus 712. A fourth fixing apparatus 715 is disposed under the second fixing apparatus 713. The third light source member 707 is disposed on the third fixing apparatus 714. The fourth light source member 708 is disposed on the fourth fixing apparatus 715.

In addition, the top plate 711 is provided with a through hole 716. A positioning camera 717 is disposed above the through hole 716. A photographing direction of the positioning camera 717 is vertical and downward. The positioning camera 717 is configured to photograph the second transmission structure 104 and the battery cell 115. Through a visual positioning manner, whether a position of the battery cell 115 is consistent with a set transmission position is determined.

In this implementation, the first transition manipulator 111 and the second transition manipulator 112 both have a same structure, and are respectively disposed on two sides of the above top plate 711. The feeding manipulator 109 and the discharging manipulator 110 both have a same structure. In this application, specific structures of the feeding manipulator 109, the discharging manipulator 110, the first transition manipulator 111, and the second transition manipulator 112 are not limited, as long as the grabbing and moving of the battery cell 115 are met.

It is to be noted that, terms “comprise”, “include” or any other variants are intended to encompass non-exclusive inclusion, such that a process, a method, an article or a device including a series of elements not only include those elements, but also includes other elements not listed explicitly or includes intrinsic elements for the process, the method, the article, or the device. Without any further limitation, an element defined by the phrase “comprising one” does not exclude existence of other same elements in the process, the method, the article, or the device that includes the elements.

Although the embodiments of the present invention have been shown and described above, it may be understood by those skilled in the art that various changes, modifications, replacements and variations can be made in these embodiments without departing from the principle and spirit of the present invention, and the scope of the present invention is defined by the appended claims and equivalents thereof.

What is claimed is:

1. A battery cell detection apparatus, comprising a feeding manipulator, a discharging manipulator, a first transition manipulator, a second transition manipulator, a first transmission structure, a second transmission structure, a third transmission structure, a first lifting structure, a second lifting structure, a first detection structure, a second detection structure, and a third detection structure, wherein the first transmission structure is disposed parallel to the third transmission structure, the feeding manipulator is disposed close to an inlet side of the first transmission structure, the discharging manipulator is disposed close to an outlet side of the third transmission structure, the first lifting structure is disposed close to an outlet side of the first transmission structure, the second lifting structure is disposed close to an inlet side of the third transmission structure, the second transmission structure is located above the first transmission structure and the third transmission structure, an inlet side of the second transmission structure is disposed close to the first lifting structure, an outlet side of the second transmission structure is disposed close to the second lifting structure, the first transition manipulator is disposed close to the inlet side of the second transmission structure and the first lifting structure, the second transition manipulator is disposed close to the outlet side of the second transmission structure and the second lifting structure, the first detection structure is disposed close to the first lifting structure, the second detection structure is disposed close to the second transmission structure, and the third detection structure is disposed close to the second lifting structure; and
the feeding manipulator is configured to feed a to-be-detected battery cell to the inlet side of the first transmission structure, a first tab and a second tab are disposed on a side of the battery cell at intervals, the first transmission structure is configured to horizontally transmit the battery cell to the first lifting structure, the first lifting structure is configured to lift the battery cell, the first detection structure is configured to photograph an inner side surface of the first tab and an outer side surface of the second tab of the battery cell located on the first lifting structure, the first transition manipulator is configured to transit the battery cell from the first lifting structure to the inlet side of the second transmission structure, the second transmission structure is configured to horizontally transmit the battery cell, the second detection structure is configured to photograph a surface of the battery cell located on the second transmission structure, the second transition manipulator is configured to transit the battery cell from the outlet side of the second transmission structure to the second lifting structure, the second lifting structure is configured to land the battery cell, the third detection structure is configured to photograph an outer side surface of the first tab and an inner side surface of the second tab of the battery cell located on the second lifting structure, the third transmission structure is configured to horizontally transmit the battery cell landed by the second lifting structure, and the discharging manipulator is configured to discharge the battery cell located on the outlet side of the third transmission structure.

2. The battery cell detection apparatus as claimed in claim 1, wherein a quantity of the battery cell detection apparatuses is two, the two battery cell detection apparatuses are in axially symmetrical arrangement.

3. The battery cell detection apparatus as claimed in claim 1, wherein the first detection structure comprises a first visual camera, a second visual camera, and a first prism, wherein the first visual camera and the second visual camera both are located on a side of the first lifting structure, a photographing direction of the first visual camera is perpendicular to a photographing direction of the second visual camera, the first prism is disposed in front of the first visual camera, a mirror surface of the first prism is configured to reflect the inner side surface of the first tab, the first visual camera is configured to photograph the mirror surface of the first prism, and the second visual camera is configured to photograph the outer side surface of the second tab.

4. The battery cell detection apparatus as claimed in claim 3, wherein the first visual camera is disposed above the second visual camera.

5. The battery cell detection apparatus as claimed in claim 1, wherein the second detection structure comprises a third visual camera and a fourth visual camera, wherein the third visual camera and the fourth visual camera are respectively located on two sides of the second transmission structure, and the third visual camera and the fourth visual camera both are configured to photograph an upper surface of the battery cell.

6. The battery cell detection apparatus as claimed in claim 5, wherein the second detection structure further comprises a fifth visual camera and a sixth visual camera, wherein the fifth visual camera is disposed under the third visual camera, the sixth visual camera is disposed under the fourth visual camera, and the fifth visual camera and the sixth visual camera both are configured to photograph a lower surface of the battery cell.

7. The battery cell detection apparatus as claimed in claim 6, wherein the second detection structure further comprises a first light source member, a second light source member, a third light source member, and a fourth light source member, wherein the first light source member and the third light source member are spaced apart from each other in an up and down manner and both are located on one side of the second transmission structure, the second light source member and the fourth light source member are spaced apart from each other in an up and down manner and both are located on the other side of the second transmission structure, the first light source member and the second light source member both irradiate towards the upper surface of the battery cell, and the third light source member and the fourth light source member both irradiate towards the lower surface of the battery cell.

8. The battery cell detection apparatus as claimed in claim 1, wherein the third detection structure comprises a seventh visual camera, an eighth visual camera, and a second prism, wherein the seventh visual camera and the eighth visual camera both are located on a side of the second lifting structure, a photographing direction of the seventh visual camera is perpendicular to a photographing direction of the eighth visual camera, the second prism is disposed in front of the seventh visual camera, a mirror surface of the second prism is configured to reflect the inner side surface of the second tab, the seventh visual camera is configured to photograph the mirror surface of the second prism, and the eighth visual camera is configured to photograph the outer side surface of the first tab.

9. The battery cell detection apparatus as claimed in claim 8, wherein the seventh visual camera is disposed above the eighth visual camera.

10. The battery cell detection apparatus as claimed in claim 1, wherein the first lifting structure comprises two vertical plates, a first chain, a second chain, a first rotary rod, a second rotary rod, a motor, and a supporting apparatus, wherein the two vertical plates are disposed opposite to each other, the first rotary rod and the second rotary rod are arranged at intervals on the two vertical plates in an up and down manner, the motor is disposed on one of the vertical plates and connected an end of the first rotary rod, top ends of the first chain and the second chain are arranged at intervals on the first rotary rod, bottom ends of the first chain and the second chain are arranged at intervals on the second rotary rod, and two ends of the supporting apparatus are respectively disposed on the first chain and the second chain.
